(19) United States
(12) Patent Application Publication
(10) Pub. No.: US 2018/0255123 A1
(43) Pub. Date: Sep. 6, 2018

(54) DISTRIBUTED RESOURCE ALLOCATION IN A FEDERATED CLOUD ENVIRONMENT

(71) Applicant: International Business Machines Corporation, Armonk, NY (US)

(72) Inventors: Nirmit V. Desai, YORKTOWN HEIGHTS, NY (US); Douglas M. Freimuth, New York, NY (US); Bong Jun Ko, Harrington Park, NJ (US); Theodoros Salonidis, Boston, MA (US); Shiqiang Wang, White Plains, NY (US)

(73) Assignee: International Business Machines Corporation, Armonk, NY (US)

(21) Appl. No.: 15/448,768

(22) Filed: Mar. 3, 2017

(51) Int. Cl. H04L 29/08; G06Q 30/02

(52) U.S. Cl. CPC H04L 67/10; G06Q 30/0206

(57) ABSTRACT

Status information associated with a set of cloud servers is received. Each cloud server in the set has an associated cloud agent, and the status information includes available computing resources and associated resource compensation information. Aggregated status information is determined for the one or more cloud servers, and the aggregated status information is forwarded to one or more of the cloud agents. A request for performing a computation is received in which the request includes a request specification. A selected cloud agent associated with one or more cloud servers most likely to accept the request based upon the aggregated status information and request specification is determined.

### TECHNICAL FIELD

The present invention relates generally to a method, system, and computer program product for allocating resources in a cloud computing environment. More particularly, the present invention relates generally to a method, system, and computer program product for distributed resource allocation in a federated cloud environment.

### BACKGROUND

Cloud computing is a type of network-based computing in which computer processing resources are hosted on one or more cloud servers by a hosting provider and shared to one or more client upon request. In cloud computing, clients pay for use of computing resources provided by one or more cloud servers. Typically, a cloud server provides for virtual server resources that are embodied within one or more physical servers. Accordingly, cloud servers provide virtual server space for a client rather than requiring the client to purchase or rent a physical server. A hosting provider will typically share computing resources with a number of clients at the same time so that different clients may utilize the same cloud server.

A federated cloud environment is a cloud environment that is composed of cloud service offerings from multiple providers and/or vendors. Typically, in a federated cloud environment software, infrastructure and platform services from disparate networks are unionized so that they can be accessed from a client via the Internet. This is facilitated by connecting public or external clouds, private or internal clouds owned by a single entity, and/or clouds owned by different entities to create the federated cloud environment.

### SUMMARY

The illustrative embodiments provide a method, system, and computer program product. An embodiment includes a method that includes receiving status information associated with a set of cloud servers. In one or more embodiments, each cloud server in the set has an associated cloud agent, and the status information includes available computing resources and associated resource compensation information. An embodiment of the method further includes determining aggregated status information for the one or more cloud servers, and forwarding the aggregated status information to one or more of the cloud agents. An embodiment of the method further includes receiving a request for performing a computation. In one or more embodiments, the request includes a request specification. An embodiment of the method further includes determining a selected cloud agent associated with one or more cloud servers most likely to accept the request based upon the aggregated status information and request specification.

An embodiment includes computer usable program product including one or more computer-readable storage devices, and program instructions stored on at least one of the one or more storage devices. The stored program instructions include program instructions to receive status information associated with a set of cloud servers. In one or more embodiments, each cloud server in the set has an associated cloud agent, and the status information includes available computing resources and associated resource compensation information. In an embodiment, the stored program instructions further include program instructions to determine aggregated status information for the one or more cloud servers, and program instruction to forward the aggregated status information to one or more of the cloud agents. In an embodiment, the stored program instructions further include program instructions to receive a request for performing a computation. In one or more embodiments, the request includes a request specification. In an embodiment, the stored program instructions further include program instructions to determine a selected cloud agent associated with one or more cloud servers most likely to accept the request based upon the aggregated status information and request specification.

In an embodiment, the computer usable code is stored in a computer readable storage device in a data processing system, and the computer usable code is transferred over a network from a remote data processing system.

In another embodiment, the computer usable code is stored in a computer readable storage device in a server data processing system, and the computer usable code is downloaded over a network to a remote data processing system for use in a computer readable storage device associated with the remote data processing system.

An embodiment includes computer system comprising one or more processors, one or more computer-readable memories, and one or more computer-readable storage devices, and program instructions stored on at least one of the one or more storage devices for execution by at least one of the one or more processors via at least one of the one or more memories. The stored program instructions include program instructions to receive status information associated with a set of cloud servers. In one or more embodiments, each cloud server in the set has an associated cloud agent, and the status information includes available computing resources and associated resource compensation information. In an embodiment, the stored program instructions further include program instructions to determine aggregated status information for the one or more cloud servers, and program instruction to forward the aggregated status information to one or more of the cloud agents. In an embodiment, the stored program instructions further include program instructions to receive a request for performing a computation. In one or more embodiments, the request includes a request specification. In an embodiment, the stored program instructions further include program instructions to determine a selected cloud agent associated with one or more cloud servers most likely to accept the request based upon the aggregated status information and request specification.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts an example of a system architecture in accordance with an illustrative embodiment;

FIG. 4 depicts a block diagram of a cloud agent in accordance with an illustrative embodiment;

FIG. 5 depicts a flowchart of an example process for a client device in accordance with an illustrative embodiment;

FIG. 6 depicts a flowchart of an example process for a cloud agent in accordance with an illustrative embodiment; and

FIG. 7 depicts a flowchart of an example process for a cloud server in accordance with an illustrative embodiment.

### DETAILED DESCRIPTION

The illustrative embodiments described herein generally relate to distributed resource allocation in a federated cloud environment. In large-scale distributed clouds, requests for the use of computing resources offered by the cloud may come from a variety of clients and be served by a number of different cloud servers within the cloud. In particular embodiments, the clouds may be owned by different commercial entities or even privately owned. A challenge arises regarding how to forward a request to a cloud server that is capable of serving the request. For example, the request may require location-specific data that is only available on a particular set of cloud servers. The capability of a cloud server to handle a request may also be subject to the resource availability and/or system compatibility of the cloud as well as other factors. In addition, each cloud may have a different resource compensation amount for performing a particular type of processing that may vary depending upon the amount of resources required for a particular computing task. Another challenge that arises regards how to find out or negotiate a resource compensation between the requestor and the cloud for processing the request at different clouds owned by different entities.

In conventional cloud computing systems, a centralize scheduler collects the status of multiple clouds and requests are submitted to the scheduler. The scheduler then decides where to route the request. In such conventional systems, certain nodes are configured to have the specific ability to schedule such requests. Adapting this ability is difficult when the system topology changes from what is originally planned, and a user must determine the scheduler to which to submit the request. Such systems in the conventional cloud computing environments are not fully distributable and scalable.

The illustrative embodiments recognize that the presently available tools or solutions do not address these problems or provide adequate solutions for these problems. The illustrative embodiments used to describe the invention generally address and solve the above-described problems and other problems related to distributed resource allocation in a federated cloud environment.

An embodiment can be implemented as a software application. The application implementing an embodiment can be configured as a modification of an existing scheduler or other component of an existing cloud infrastructure, as an application executing in a data processing system communicating with an existing component of a cloud infrastructure, a standalone application, or some combination thereof.

In accordance with one or more embodiments, a network-based distributed system is provided which contains multiple cloud servers and cloud agents. In one or more embodiments, a cloud agent receives a request for a cloud service. In one or more embodiments, the cloud agent aggregates status information of available resources and resource compensation amounts for multiple clouds. In one or more embodiments, the cloud agent determines which cloud or set of clouds is likely to satisfy the request. In one or more embodiments, the cloud agent forwards the request to a next hop cloud agent corresponding to the set of clouds. In at least one embodiment, the cloud agent may further negotiate a resource compensation amount for performing the computing process with one or more clouds. In one or more embodiments, if a particular cloud accepts and processes the user request, the cloud agent may receive a result of the computing process from the cloud server and provide the result to a client device associated with the user. In other embodiments, the cloud server may provide the computing process result directly to the client device.

In one or more embodiments, a cloud agent is a virtual entity which is integrated into a network element such as a network gateway, a router, or one or more cloud servers. In at least one embodiment, a cloud agent includes a functionality of aggregating status information on available computing resources including for a plurality of cloud servers within a federated cloud environment. Computing resources that may be identified within the status information include for example, available processors (such as available central processing units (CPUs), graphics processing units (GPUs) or processing cores), platform settings (such as an operating system), resource compensation information, and available memory.

In one or more embodiments, the cloud agent further acts as a representative between a requesting user and cloud servers by accepting/rejecting cloud processing from users and finding suitable next-hop(s) to forward the requests. In at least one embodiment, the cloud agent may further negotiate a resource compensation amount between the user and one or more cloud servers for performing the requested computing process.

In at least one embodiments, a distributed protocol is used to exchange information between one or more cloud agents as well as between cloud agents and cloud servers. In particular embodiments, a cloud agent is only aware of the connection to the cloud agent's one or two hop neighboring cloud agents and is not aware of the entire system topology.

In one or more embodiments, each cloud server regularly updates status information associated with the cloud server to a nearby cloud agent. In particular embodiments, the status information includes a current state of the cloud server and resource compensation information associated with available computing resources of the cloud server. Examples of a current state includes information indicative of available computing resources, platform settings, available processors, and available memory of the cloud server. Examples of resource compensation information includes compensation amount per CPU block and compensation amount per memory block.

In one or more embodiments, when a user has a cloud processing request, the user submits the request including a request specification to a nearby cloud agent from a client device. The user can be a human user, a system, or an application, that is capable of presenting a request. In one or more embodiments, the request specification includes a specification of a requested computing resource, an indication of an acceptable compensation amount, and any other requirement requested by the user. In particular embodiments, the request specification may include one or more of a number of required CPU and memory blocks, a resource compensation amount the user is willing to provide to a cloud server to complete the request, a platform setting (such as an operating system) according to the request, as well as any other requirement such as a deadline for finding a cloud server to accept the request.

In one or more embodiments, a cloud agent aggregates the status information of multiple cloud servers to determine the most likely cloud server or set of cloud server to satisfy the request based on the request specification. The cloud agent finds a next hop cloud agent to where the request should be forwarded. The cloud agent forwards the user request to a destination cloud server. In particular embodiments, the request may be forwarded by multiple hops of cloud agents to reach the destination cloud server. In one or more embodiments, the cloud agent receives the results of the cloud computing request from the cloud server or another cloud agent and forwards the results to the client device associated with the user.

The illustrative embodiments are described with respect to certain types of cloud computing, transmissions, validations, responses, agents, requests, resources, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

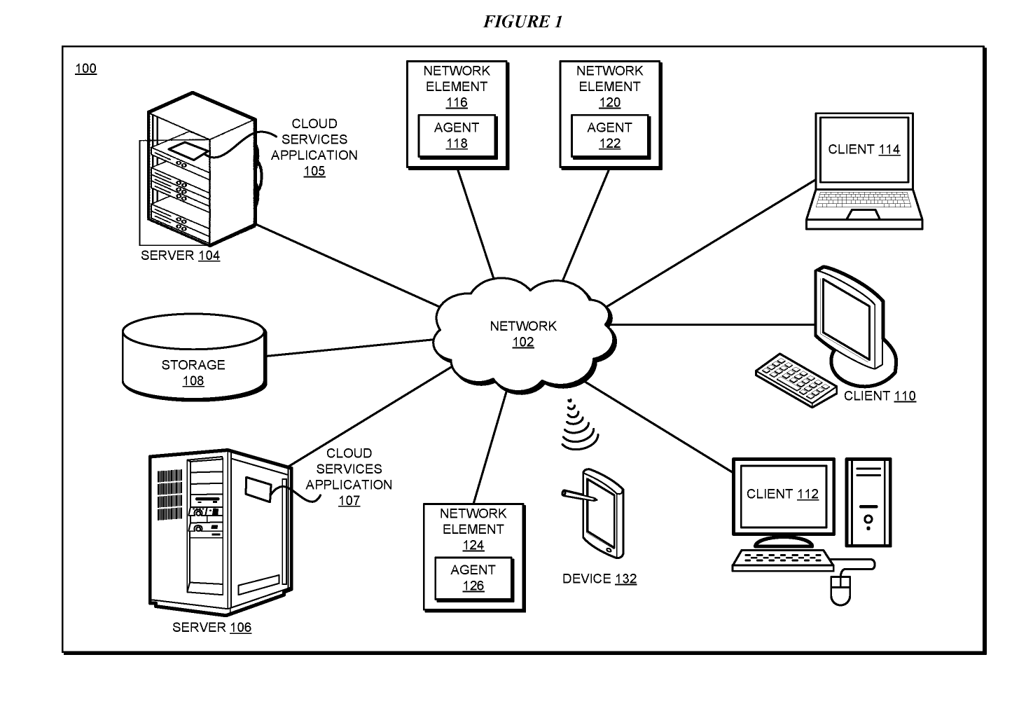

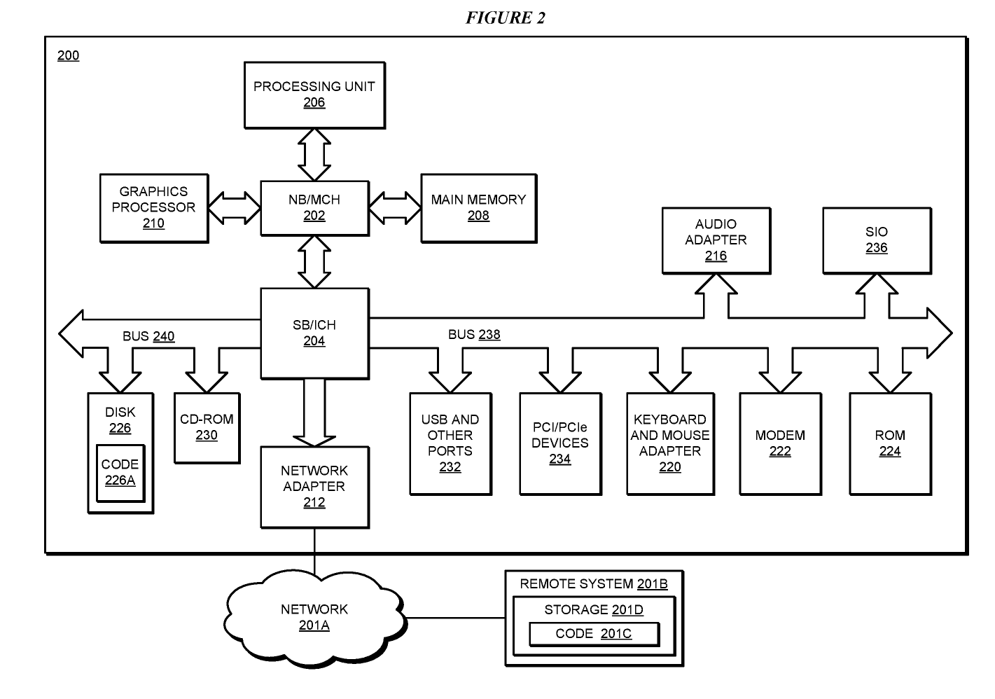

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Cloud services application 105 of server 104 implements an embodiment of a cloud server described herein. Similar, cloud services application 107 implements another cloud server as described herein with respect to various embodiments.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

A first network element 116 includes a first cloud agent 118, a second network element 120 includes a second cloud agent 122, and a third network element 124 includes a third cloud agent 126. Each of first network element 116, second network element 120, and third network element 124 are in communication with network 102. In particular embodiments, one or more of first network element 116, second network element 120, and third network element 124 comprise an embodiment within a network gateway, a router, a cloud server, or any other suitable network element. Each of first cloud agent 118, second cloud agent 122, and third cloud agent 126 implement an embodiment described herein, are associated with one or more cloud servers, such as server 104 or server 106, and function as cloud agents as further described herein.

In accordance with one or more embodiments, a user may utilize client 110, 112, or 114 to send a request for a computing process to be performed by one or more of cloud servers to one or more of first cloud agent 118, second cloud agent 122, and third cloud agent 126. In at least one embodiment, one or more of first cloud agent 118, second cloud agent 122, and third cloud agent 126 aggregates status information of a number of cloud servers, and forwards the request to a suitable next hop cloud agent associated with a cloud server likely to accept the request as further described herein.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, cloud agents such as cloud agents 118, 122, 126, and applications or programs, such as cloud service applications 105 and 107 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

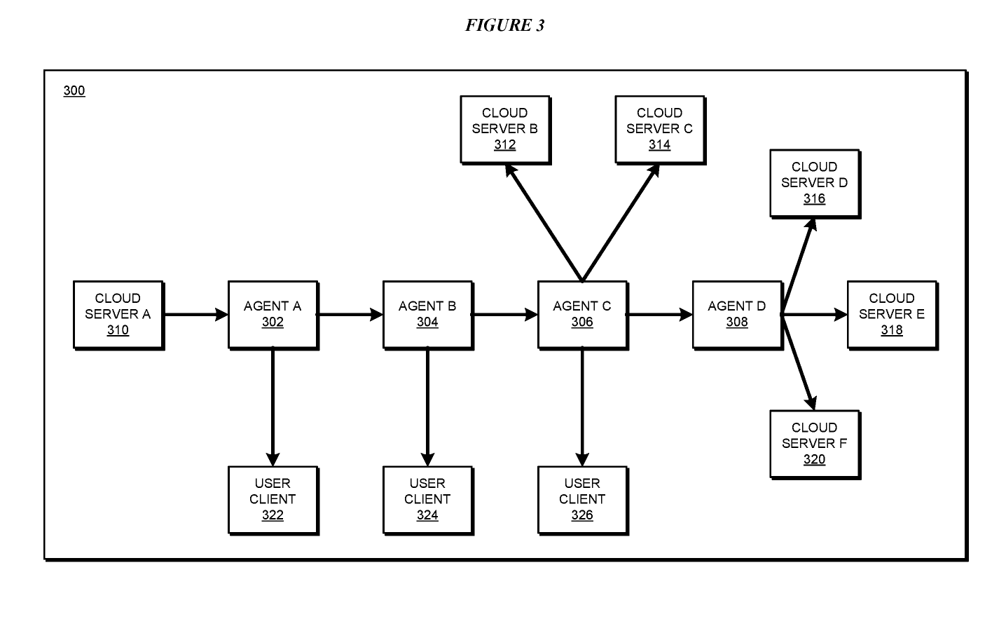

With respect to FIG. 3, this figure depicts an example of a system architecture 300 in accordance with an illustrative embodiment. The system architecture 300 includes cloud agent A 302 in communication with cloud agent B 304, and cloud agent B 304 is in further communication with cloud agent C 306. Cloud agent C 306 is in further communication with cloud agent D 308. Cloud agent A 302 is in communication with and associated with cloud server A 310. Cloud agent C 306 is in communication with and associated with cloud server B 312 and cloud server C 314. Cloud agent D 308 is in communication with and associated with cloud server D 316, cloud server 318, and cloud server F 320. Cloud server A 302 is in communication with a user client device 322, cloud server B 304 is in communication with user client device 324, and agent C 306 is in communication with client device 326.

In accordance with at least one embodiment, each of cloud servers 310-320 regularly updates status information to a respective nearby cloud agent 302-308. In particular, cloud server A 310 sends status information to cloud agent A 302. Cloud server B 312 and cloud server C 314 each send status information to cloud agent C 306. Cloud server D 316, cloud server E 318, and cloud server F 320 each send status information to cloud agent D 308. In particular embodiments, the status information includes a current state of the cloud server and resource compensation information associated with computing resources of the cloud server. Examples of a current state includes information indicative of available computing resources, platform settings, available processors, and available memory of the cloud server. Examples of resource compensation information includes compensation per CPU block and compensation per memory block.

In one embodiment, each cloud server 310-320 proactively sends the cloud server's current status to one or more associated cloud agents 302-308 in regular and/or periodic intervals. In another embodiment, each cloud server 310-320 reactively exchanges status information with one or more associated cloud agents 302-308 when there is an active user request, and cloud agents 302-308 are configured to determine the cloud servers 302-308 to query and sends a query to the determined cloud servers requesting the status information. In still another embodiment, a combination of proactive and reactive approaches is used by cloud server 310-320 and cloud agents 302-308. For example, cloud server 310-320 may proactively send status information to associated cloud agents 302-308 at a large regular update interval, and reactively send status information to associated cloud agents 302-308 in response to an active user request.

In one or more embodiments, each of cloud agents 302-308 aggregates the status information received from each associated cloud server to determine aggregated status information. In a particular example, cloud agent C 306 aggregates the status information received from each of cloud server B 312 and cloud server C 314 to determine aggregated status information for cloud server B 312 and cloud server C 314. In another particular example, cloud agent D 308 aggregates the status information received from each of cloud server D 316, cloud server E 318, and cloud server F 320, and determines aggregate status information for cloud server D 316, cloud server E 318, and cloud server F 320. In one or more embodiments, each of cloud agents 302-208 stores the aggregate status information within a memory or other storage device.

In one or more embodiments, when aggregating the resource status information of multiple cloud servers, each of cloud agents 302-308 can use a variety of aggregation methods, including summation, histogram, spectrogram, and other statistical summarization.

In one or more embodiments, each of cloud agents 302-308 computes an aggregated resource metric of the current resource availability and an aggregated compensation metric of the cloud servers associated with the particular cloud agent. In a particular example, cloud agent 306 C computes an aggregated resource metric for cloud server B 312 and cloud server C 314, and an aggregated compensation metric for cloud server B 312 and cloud server C 314. In at least one embodiment, each of cloud agent 302-308 stores the aggregated resource metric and aggregated compensation metric within one or more tables. In some embodiments, the aggregated metrics may be computed either from other aggregated metrics or from direct measures of resource availability and cloud server resource compensation amounts.

In at least one embodiment, each of cloud agents 302-308 sends the aggregated status information to one or more nearby cloud agents. For example, cloud agent C 306 may send aggregated status information of cloud server B 312 and cloud server C 314 to cloud agent B 304 and fourth cloud agent D 308.

In one or more embodiments, each of cloud agents 302-308 computes an aggregated resource metric of the current resource availability and an aggregated compensation metric by combining those of directly connected cloud servers and those received from other cloud agents. For example, cloud agent C 306 aggregates the resource metric received from cloud agent D 308 with the resource metric received from cloud server B 312 and cloud server C 314.

In one or more embodiments, one of cloud agents 302-308 receives a user request for cloud computing from one of user clients 322, 324, and 326. In a particular example, cloud agent B 304 receives a user request for cloud computing from user client device 324. In particular embodiments, the user request includes a request specification that includes a specification of requested computing resources, an indication of an acceptable resource compensation amount, and any other requirements requested by the user. In at least one embodiments, a cloud agent matches the request specification to the stored aggregate status information to determine if one or more cloud servers are likely to be able to satisfy the user's request, and forward the request to a next hop cloud agent associated with the one or more cloud servers. In one or more embodiments, the request continues to be forwarded between cloud agents until either a cloud server matching the resource and compensation criteria is found or no cloud servers are found that match the resource and compensation criteria.

In a particular example, if cloud agent B 304 receives a user request including a request specification from user client device 324, cloud agent B 304 may determine that one or more of cloud server B 312 and cloud server C 314 is most likely to satisfy the request. In the particular example, cloud agent B 304 forwards the request to cloud agent C 306. Cloud agent C 306 determines if the resource and compensation criteria is most likely to be accepted by one or more of cloud server B 312 and cloud server C 314, and sends the request to one or more of cloud server B 312 and cloud server C 314 if it is likely to be accepted. Alternately, cloud agent C 304 may forward the request to cloud agent D 308 if it determines that one or more of cloud server D 316, cloud server E 318, or cloud server F 320 is mostly likely to satisfy the request.

In one or more embodiments, at each sequence of cloud agent forwarding as well as at a destination cloud server, negotiation on compensation amount and matching for resource availability takes place. If a request cannot be satisfied by one or more cloud servers 310-318 that a particular cloud agent can forward to, the particular cloud agent sends a FAIL message to a corresponding last hop cloud agent. The last hop cloud agent forwards the request to another neighboring cloud agent that it determines as having a high likelihood of accommodating the request. If no cloud server can accommodate the request, or if a deadline of cloud search has been exceeded, a FAIL message is sent to the user client device via a corresponding nearby cloud agent. In particular embodiments, the FAIL message may contain a reason for the failure (e.g., the expected compensation amount is too low or required resources are not available). In one or more embodiments, the user may adjust the specification and resubmit the request to determine if the new specification is able to be met by one or more cloud servers.

In particular embodiments, one or more of cloud agents 302-308 may include a buffer configured to store recent failures of requests for particular combinations of resources and/or compensation amounts. This buffer is usable to reject such requests so that these failures can be avoided without querying the cloud server.

In one embodiment, a process of resource compensation amount negotiation may include submitting a maximum compensation amount that can be allocated (e.g., per hour) for a given request to a cloud agent. A cloud server submits an asking compensation amount configured therein for each type of resource available at the cloud server to the cloud agent. The cloud agent may determine whether the user's maximum compensation amount is below the cloud server's asking compensation amount for the entirety of the user's requested resources.

In one or more embodiments, if a cloud server has accepted the request, the cloud server sends a SUCCESS message via one or more cloud agents to the user client device. Depending upon a request type, the cloud server may establish a direct connection with the user device. In particular embodiments, data to be processed by the computing process may be included within the request or in a remote repository indicated in the request. In other particular embodiments, the computation to be performed on the data may be included in the request, in a remote processing cloud, or in a remote repository as indicated by the request. In at least one embodiment, when a cloud server finishes processing the request, a COMPLETED message including the computation result is sent via one or more of cloud agents 302-308 to the user client device.

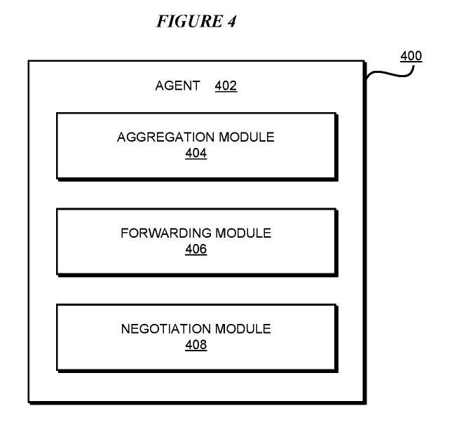

With respect to FIG. 4, this figure depicts a block diagram 400 of a cloud agent 402 in accordance with an illustrative embodiment. The cloud agent 402 includes an aggregation module 404, a forward module 406, and a negotiation module 408. In one or more embodiments, aggregation module 404 is configured to receive status information updates from individual cloud servers, receive aggregated status information of a collection of cloud servers from other cloud agents, and determine aggregate status information from the received status information from individual servers and the aggregated status information received from other cloud agents.

In one or more embodiments, forwarding module 406 is configured to receive user requests either directly from user client devices or from other cloud agents, determine one or more cloud servers most likely able to accept the request based on aggregated status information received from neighboring cloud agents and/or status updates directly from cloud servers, and determine the next hop where the user request should be forwarded based on the status information. In one or more embodiments, forwarding module 406 is further configured to forward user requests to a destination cloud server, possible via multiple hops of cloud agents, receiving a computation result from a cloud server, and send the computation result to the user client device.

Negotiation module 408 is configured to serve as a broker for resource compensation negotiation to represent users and cloud servers in a negotiation process to determine a compensation amount that is acceptable to both the user and the cloud server to perform a particular requested computation.

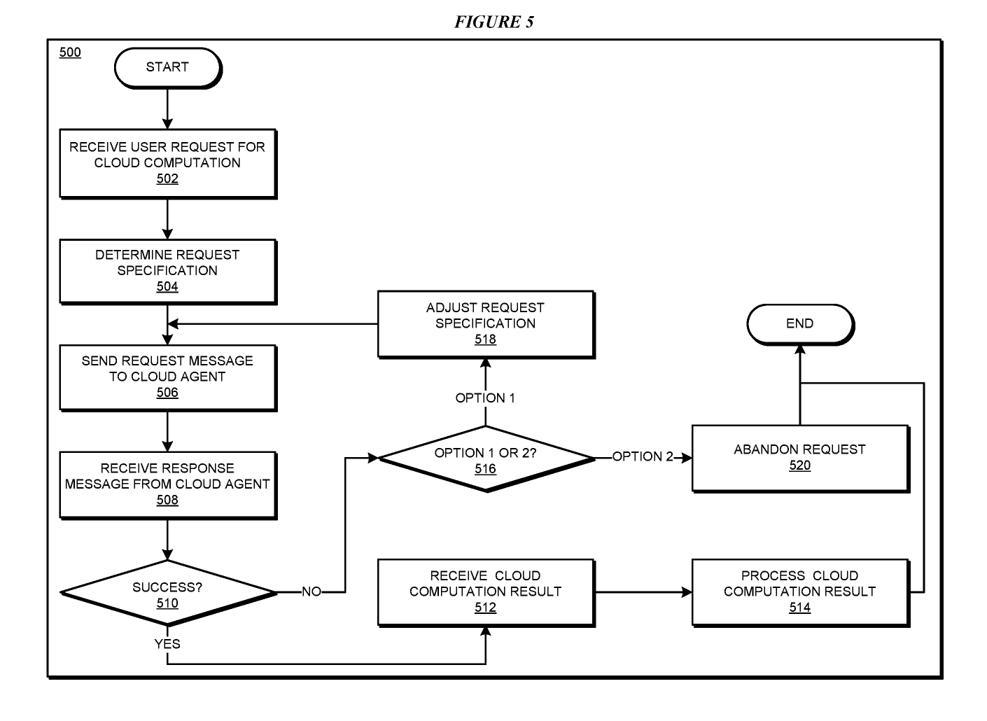

With respect to FIG. 5, this figure depicts a flowchart of an example process 500 for a client device in accordance with an illustrative embodiment. In particular embodiments, the user client device includes one or more of client devices 110-112 of FIG. 1 and user client devices 322-326 of FIG. 3. In block 502, the client device receives a user request for a cloud computation that is desired to be performed by one or more cloud servers. In block 504, client device determines a request specification corresponding to the user request. In at least one embodiment, the request specification includes a specification of requested computing resources to perform the cloud computation and an indication of an acceptable compensation amount for performing the cloud computation. In block 506, the client device sends a request message including the request specification to a cloud agent. In particular embodiments, the cloud agent is a nearby cloud agent. In one or more embodiments, the cloud agent may determine a next hop cloud agent or destination cloud server to forward the request based upon aggregate status information and receive a response message from a cloud server indicative of whether the cloud server has accepted the request for the cloud computation using the requested computing resources meeting the requested compensation amount.

In block 508, the client device receives a response message from the cloud agent. In block 510, the client device determines whether the response message is indicative of a cloud server was successful in accepting the request. If the response message is not indicative of a success (e.g., the response message is indicative of a failure of a cloud server to accept the request), the process continues to block 516. In 516, client device determines whether a first option or a second option of handling failed requests is to be followed. If the first option is followed, in block 518, the client device adjusts the request specification such as raising the acceptable compensation amount or changing the requested computing resources. In a particular embodiment, the client device prompts the user to provide an adjusted request specification. If the second option is followed, in block 520 the client device abandons the request and the process 500 ends.

If the response message is indicative of a success, in block 512 the client device receives the cloud computation result from the cloud server either directly from the cloud server or via one or more cloud agents. In block 514, the client device processes the cloud computation result. In a particular embodiment, the client device may process the computation result by providing the computation result to the user. Process 500 is ended thereafter.

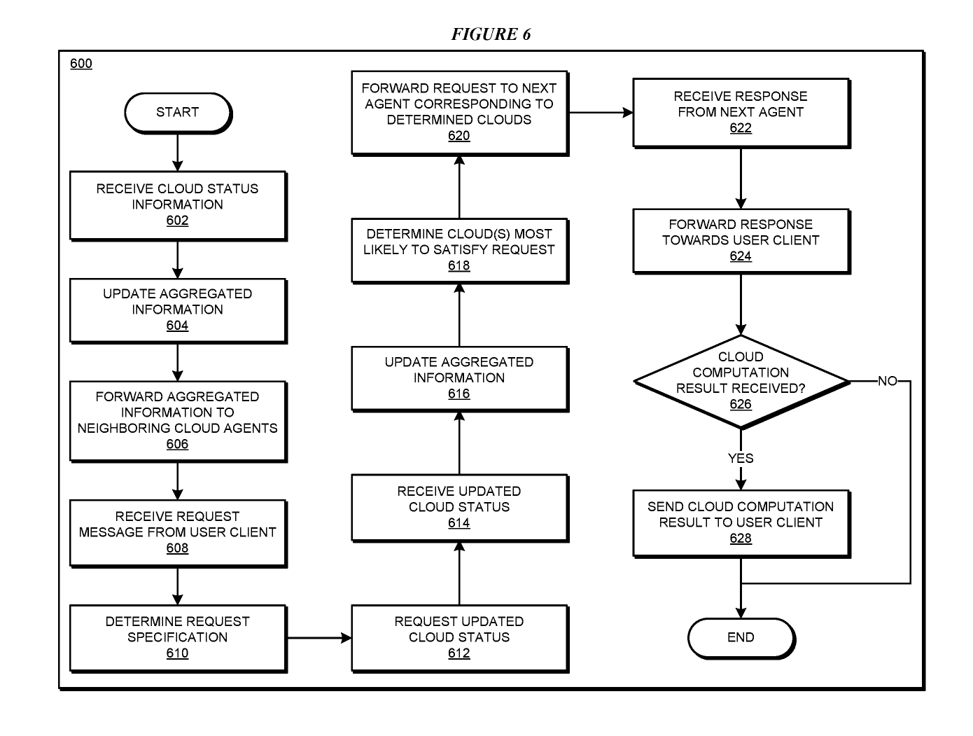

With reference to FIG. 6, this figure depicts a flowchart of an example process 600 for a cloud agent in accordance with an illustrative embodiment. In particular embodiments, the cloud agent may include one or more of cloud agents 118, 122, and 126 of FIG. 1, and cloud agents 302-308 of FIG. 3. In block 602, the cloud agent receives cloud status information from one or more cloud servers associated with the cloud agent. In 604, the cloud agent determines aggregated status information for the one or more cloud servers to provide updated aggregated status information for the one or more cloud servers. In particular embodiments, the cloud agent may further receive aggregated cloud status information from one or more neighboring cloud agents and utilize the aggregated cloud status information received from the neighboring cloud agents to update the cloud agent's own aggregate status information. In block 606, the cloud agent forwards the aggregated status information to one or more neighboring cloud agents.

In block 608, the cloud agent receives a request message for performing a cloud computation from a user client device including information indicative of a request specification. In one or more embodiments, the request specification includes a specification of requested computing resources to perform the cloud computation and an indication of an acceptable compensation amount for performing the cloud computation. In block 610, the cloud agent determines the request specification from the information in the request message.

In block 612, the cloud agent requests updated cloud status from one or more cloud servers and/or cloud agents. In block 614, the cloud agent receives the updated cloud status information. In block 616, the cloud agent updates the aggregated status information based upon the received updated cloud status information. In an alternative embodiment, the procedures performed in blocks 612-616 may be omitted.

In block 618, the cloud agent determines one or more clouds most likely to satisfy/accept the request based upon the request specification. In block 620, the cloud agent forwards the request to the next cloud agent corresponding to the one or more cloud servers determined most likely to satisfy the request. In one or more embodiments, if no suitable cloud server has been found to accept the request, the cloud agent may send a FAIL message to the previous hop cloud agent and/or a client device.

In block 622, the cloud agent receives a response message from the next cloud agent. In block 624, the cloud agent forwards the response message toward the user client device, either directly or via one or more other cloud agents. In one or more embodiments, the response message may include a FAIL message, a SUCCESS message, or a COMPLETED MESSAGE. In particular embodiments, a FAIL message is indicative of no cloud server being found to accept the request, a SUCCESS message is indicative of one or more cloud servers being found to accept the request, and a COMPLETED message is indicative of the one or more cloud servers completing the request cloud computation.

In block 626, the cloud agent determines whether the cloud computation result has been received. If the cloud computation result was not been received, the process 600 ends. If the cloud agent determines that the cloud computation result has been received, in block 628 the cloud agent sends the cloud computation result toe the user client device either directly or via one or more other cloud agents. Process 600 is ended thereafter.

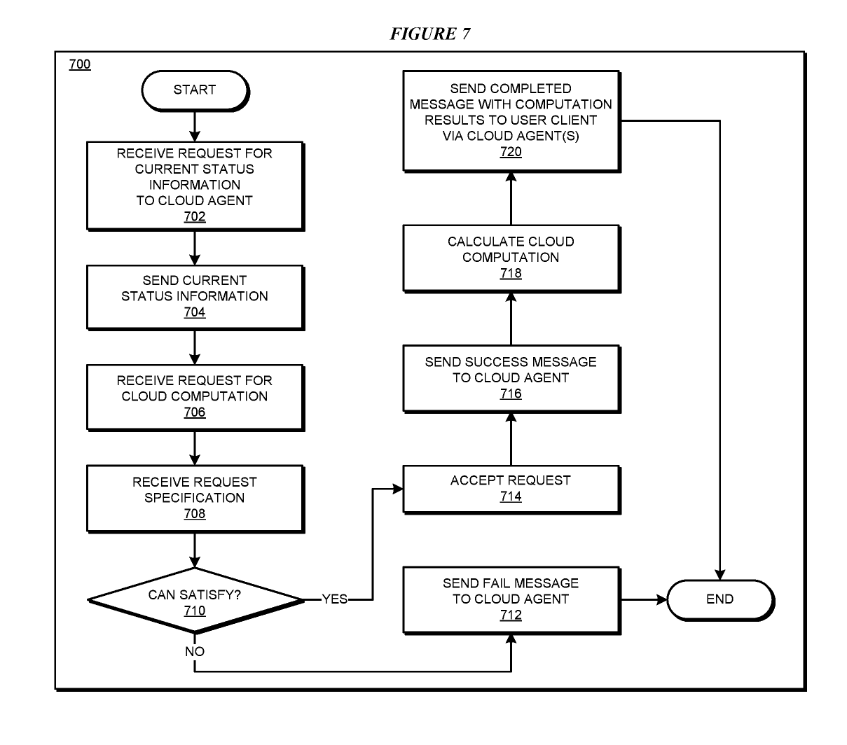

With reference to FIG. 7, this figure depicts a flowchart of an example process 700 for a cloud server in accordance with an illustrative embodiment. In particular embodiments, the cloud server may include one or more of servers 104 and 106 of FIG. 1, and cloud servers 310-320 of FIG. 3. In block 702, the cloud server receives a request for current status information from a cloud agent. In 704, the cloud server sends the current status information to the cloud agent. In block 706, the cloud server receives a request for cloud computation from the cloud agent. In one or more embodiments, the request for cloud computation originates with a client device and is provided to the cloud agent or another previous hop cloud agent.

In block 708, the cloud server receives a request specification corresponding to the request. In block 710, the cloud server determines whether the cloud server can satisfy the request based upon the request specification. If the cloud server determines that the request cannot be satisfied, in block 712 the cloud server sends a FAIL message to the cloud agent and process 700 is ended.

If the cloud server determines that the request can be satisfied, in block 714 the cloud server accepts the request. In 716, the cloud server sends a success message to the cloud agent indicated that the request has been successfully accepted by the cloud server. In 718, the cloud server calculates the requested cloud computation. In block 720, the cloud server sends a completed message with the computation result to the user client device via one or more cloud agents. Process 700 is ended thereafter.

Thus, a computer implemented method, system or apparatus, and computer program product are provided in the illustrative embodiments for distributed resource allocation in a federated cloud environment and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
receiving status information associated with a set of cloud servers, each cloud server in the set having an associated cloud agent, and the status information including available computing resources and associated resource compensation information;
determining aggregated status information for the one or more cloud servers;
forwarding the aggregated status information to one or more of the cloud agents;
receiving a request for performing a computation, the request including a request specification; and
determining a selected cloud agent associated with one or more cloud servers most likely to accept the request based upon the aggregated status information and request specification.

2. The method of claim 1, wherein determining the aggregated status information includes:
computing an aggregated resource metric of current resource availability of the one or more cloud servers associated with the cloud agent, and current resource availability of the one or more cloud servers associated with other cloud agents; and
computing an aggregated compensation metric of the one or more cloud servers associated with cloud agent, and of the one or more cloud servers associated with other cloud agents.

3. The method of claim 1, further comprising forwarding the request to the selected cloud agent.

4. The method of claim 1, further comprising receiving a response indicative of whether a cloud server has accepted the request.

5. The method of claim 1, further comprising receiving a result of the computation result.

6. The method of claim 5, further comprising forwarding the result of the computation towards a client device.

7. The method of claim 1, wherein the request specification includes a specification of requested computing resources and an indication of an acceptable compensation amount.

8. The method of claim 1, wherein the selected cloud agent is a next hop cloud agent to which the request is forwarded.

9. The method of claim 1, further comprising negotiating a compensation amount for calculating the computation result with one or more of the cloud servers.

10. A computer usable program product comprising one or more computer-readable storage devices, and program instructions stored on at least one of the one or more storage devices, the stored program instructions comprising:
program instructions to receive status information associated with a set of cloud servers, each cloud server in the set having an associated cloud agent, and the status information including available computing resources and associated resource compensation information;
program instructions to determine aggregated status information for the one or more cloud servers;
program instruction to forward the aggregated status information to one or more of the cloud agents;
program instructions to receive a request for performing a computation, the request including a request specification; and
program instructions to determine a selected cloud agent associated with one or more cloud servers most likely to accept the request based upon the aggregated status information and request specification.

11. The computer usable program product of claim 10, further comprising:
program instructions to compute an aggregated resource metric of current resource availability of the one or more cloud servers associated with the cloud agent, and current resource availability of the one or more cloud servers associated with other cloud agents; and
program instructions to compute an aggregated compensation metric of the one or more cloud servers associated with cloud agent, and of the one or more cloud servers associated with other cloud agents.

12. The computer usable program product of claim 10, further comprising:
program instructions to forward the request to the selected cloud agent.

13. The computer usable program product of claim 10, further comprising:
program instructions to receive a response indicative of whether a cloud server has accepted the request.

14. The computer usable program product of claim 10, further comprising:
program instructions to receive a result of the computation result.

15. The computer usable program product of claim 10, further comprising:
program instructions to forward the result of the computation towards a client device.

16. The computer usable program product of claim 10, wherein the request specification includes a specification of requested computing resources and an indication of an acceptable compensation amount.

17. The computer usable program product of claim 10, wherein the computer usable code is stored in a computer readable storage device in a data processing system, and wherein the computer usable code is transferred over a network from a remote data processing system.

18. The computer usable program product of claim 10, wherein the computer usable code is stored in a computer readable storage device in a server data processing system, and wherein the computer usable code is downloaded over a network to a remote data processing system for use in a computer readable storage device associated with the remote data processing system.

19. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to receive status information associated with a set of cloud servers, each cloud server in the set having an associated cloud agent, and the status information including available computing resources and associated resource compensation information;
program instructions to determine aggregated status information for the one or more cloud servers;
program instruction to forward the aggregated status information to one or more of the cloud agents;
program instructions to receive a request for performing a computation, the request including a request specification; and
program instructions to determine a selected cloud agent associated with one or more cloud servers most likely to accept the request based upon the aggregated status information and request specification.

20. The computer system of claim 19, the stored program instructions further comprising:
program instructions to compute an aggregated resource metric of current resource availability of the one or more cloud servers associated with the cloud agent, and current resource availability of the one or more cloud servers associated with other cloud agents; and
program instructions to compute an aggregated compensation metric of the one or more cloud servers associated with cloud agent, and of the one or more cloud servers associated with other cloud agents.
